(19) United States
(12) Patent Application Publication
(10) Pub. No.: US 2002/0060145 A1
(43) Pub. Date: May 23, 2002

(54) Modular conveyor

(76) Inventors: Richard E. Doerfer, Cape Coral, FL (US); Sharon La Fontaine, Cape Coral, FL (US); Willy R. Hidalgo, Cape Coral, FL (US); Richard P. Scherch, Fort Meyers, FL (US)

Correspondence Address: Lowell Anderson, Stetina Brunda Garred & Brucker, Suite 250, 75 Enterprise, Aliso Viejo, CA, 92656, US

(21) Appl. No.: 09/788,869

(22) Filed: Feb. 20, 2001

Related U.S. Application Data
(60) Provisional application No. 60/183,936, filed on Feb. 22, 2000.

(51) Int. Cl. B65G 21/00

(52) U.S. Cl. 198/860.2

(57) ABSTRACT

A modular conveyor is provided that is assembled from components shipped as a kit to form a conveyor of variable configuration. The conveyor has side rails on opposing sides of the conveyor belt, with holes in the side rails adapted to allow mounting of supports at various locations. Holes in the ends of the side rails allow connections to end supports that contain hoppers, chutes or belt drive units comprising motors, gearboxes and drive shafts. Adjustable length legs have a U-shaped bracket that may be locked in a vertical position for supporting a horizontal conveyor, or angled to support an inclined conveyor segment. The legs are preferably pinned together for increased stability.

A modular conveyor is provided that is assembled from components shipped as a kit to form a conveyor of variable configuration. The conveyor has side rails on opposing sides of the conveyor belt, with holes in the side rails adapted to allow mounting of supports at various locations. Holes in the ends of the side rails allow connections to end supports that contain hoppers, chutes or belt drive units comprising motors, gearboxes and drive shafts. Adjustable length legs have a U-shaped bracket that may be locked in a vertical position for supporting a horizontal conveyor, or angled to support an inclined conveyor segment. The legs are preferably pinned together for increased stability.

### BRIEF DESCRIPTION OF THE DRAWINGS

FIG. 1 shows a modular conveyor with portions of conveyor omitted for illustration;

FIG. 2 shows a portion of the conveyor of FIG. 1;

FIG. 3 shows a portion of the conveyor of FIG. 1;

FIG. 4 is a view of an upper end support of the conveyor of FIG. 1;

FIG. 5 is a view of a lower end support of the conveyor of FIG. 1;

FIG. 6 is a view of stacked modular conveyors, using a modular conveyor of FIG. 1;

FIG. 7 is a view of an upper angled connector of the conveyor of FIG. 1;

FIG. 8 is a view of a lower angled connector of the conveyor of FIG. 1;

FIG. 9 is a view of an H-bracket used on the supports of the conveyor of FIG. 1;

FIG. 10 is a view of a support bracket used on the conveyor of FIG. 1; and

FIG. 11 is a partial sectional view taken along section 11-11 of FIG. 6.

### DETAILED DESCRIPTION

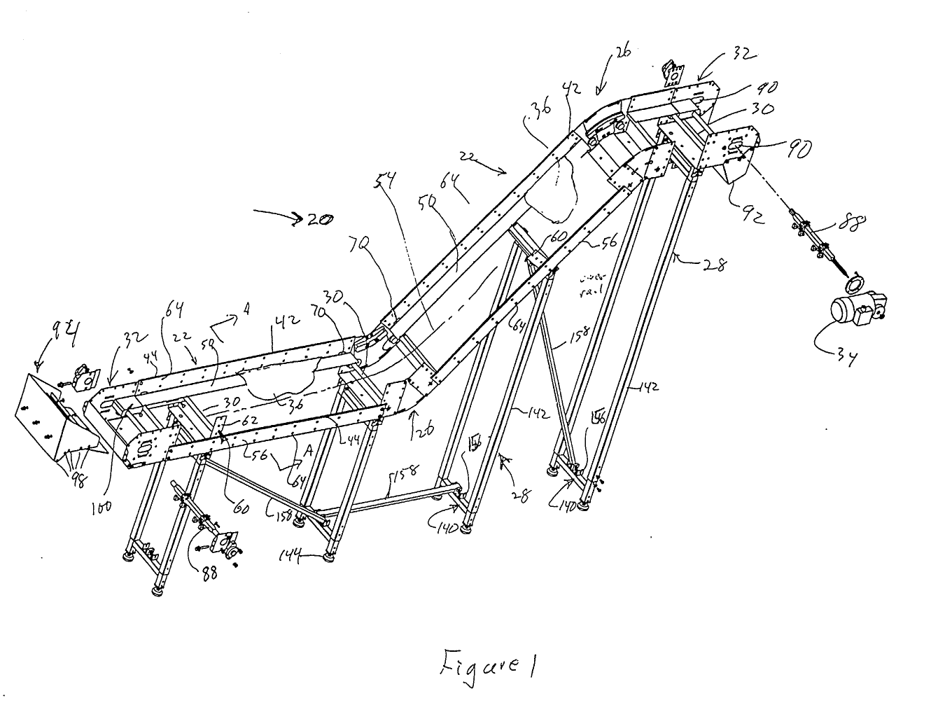

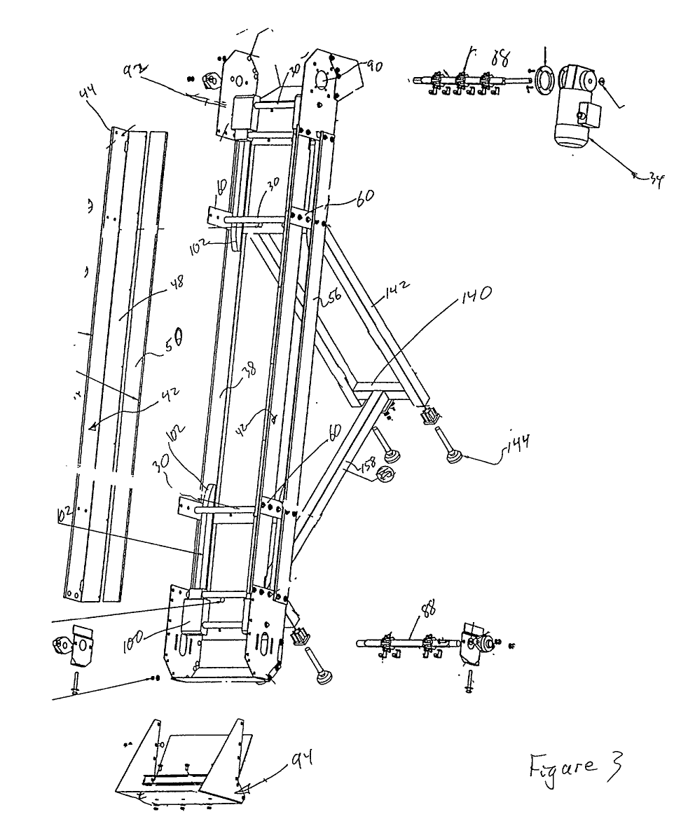

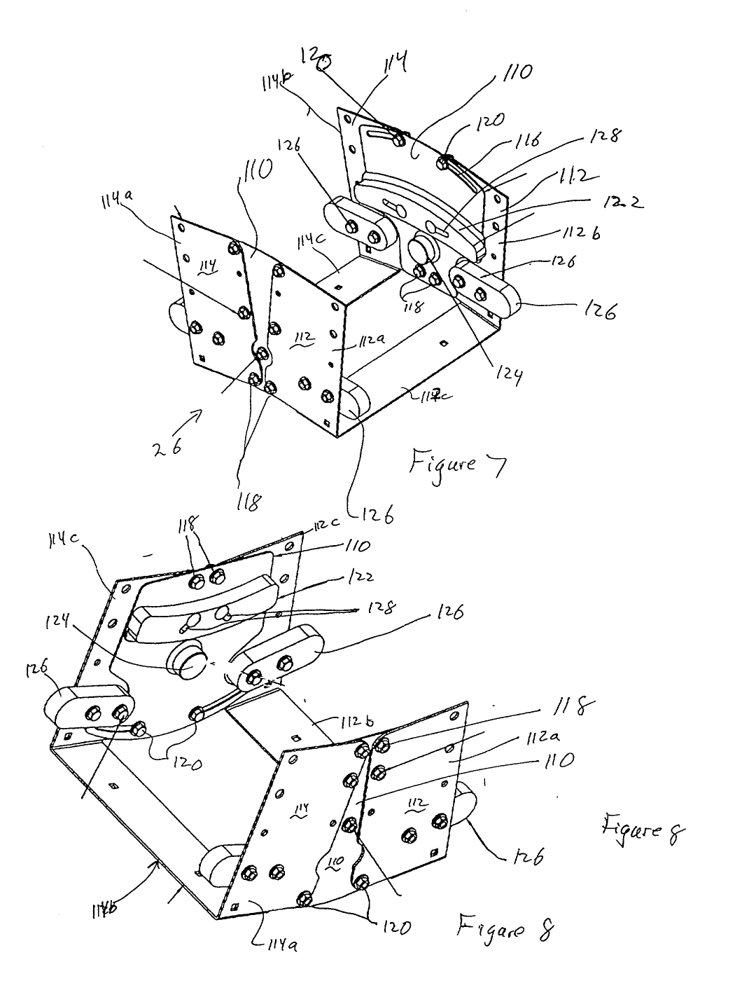

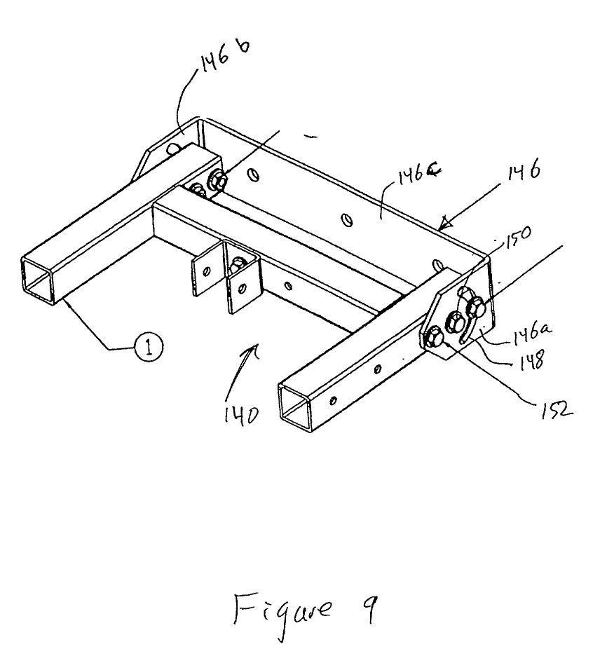

Referring to FIGS. 1-3, a modular conveyor 20 is provided that can be assembled on site from components shipped to the designated site in a kit. A plurality of conveyor segments 22 are joined end-to-end by one of a straight connector 24 or a curved connector 26. The curved connector 26 can comprise a downwardly curved connector 26a or an upwardly curved connector 26b, each of which are shown in more detail in FIGS. 7 and 8, respectively. Vertically adjustable legs 28 are connected at various locations to the conveyor 20, with the legs 28 being stabilized by stabilizing rods 30. An end support 32 is located at least at one end of the conveyor 20 so that a motor 34 can be drivingly connected to move the conveyor belt 36 (FIG. 1), although the motor 34 can be drivingly connected to move the belt 36 in a variety of other ways. Advantageously there are end supports 32 at opposing ends of the conveyor. The conveyor 20 may be vertically stacked (FIG. 6) by connecting brackets 38 between the stacked conveyors 20.

As used herein, the term upper, lower, above, below, top and bottom will refer to relative vertical position as depicted in FIG. 1. The terms lateral or transverse will refer to the horizontal direction.

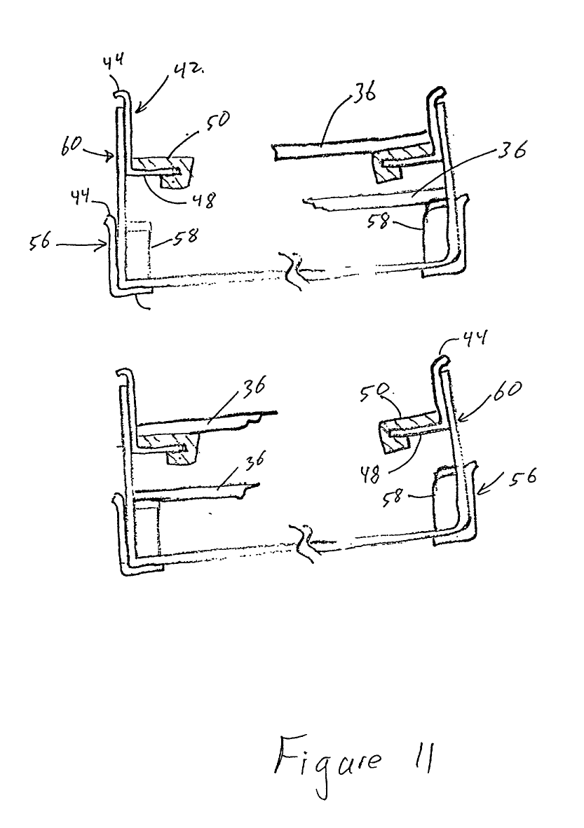

Referring to FIGS. 1-3 and 6, each conveyor segment 22 advantageously comprises a pair of upper side rails 42 parallel to each other and spaced apart a distance sufficient to accommodate conveyor belt 36 (FIG. 1). For clarity, the belt 36 is not shown in most figures, and one of the upper side rails 42 is omitted in FIGS. 1-3. Referring to FIG. 10, each of the side rails 42 have a vertical support member and a support 48 extending at an angle thereto to support the belt 36. The upper side rails 42 preferably are L shaped, with a flat, vertical side 46 and a lateral support 48 at the lower end of the vertical side 46 that extends toward the opposing side rail 42. If the conveyor segment 22 is horizontal, then the lateral support 48 is horizontal.

A wear strip 50 is connected to the lateral support 48. The wear strip 50 supports the bottom of the conveyor belt 36, and thus the strip 50, and the support 48, must extend underneath the belt 36 along a length of the belt 36 sufficient to provided the required support and must extend underneath the width of the belt 36 a distance sufficient to provide the required support. The amount of support will vary with the use to which the conveyor is put. The wear strip 50 is made of material suitable for its intended use. A UHMW (ultra high molecular weight) polyethylene is suitable. The wear strip 50 is advantageously shaped to comprise an elongated strip having a J shaped cross section, with the bottom of the J cupping the free edge of the lateral support 48. The lateral support 48 is preferably deformed periodically to fasten the strip 50 to the support 48. As seen in FIG. 10, punching or drilling a hole 52 so as to cause a protruding edge will leave a recess into which the strip 50 will deform, and will also cause a protrusion that extends slightly into the strip 50 in order to grip and hold the strip 50. Other fastening methods can be used to hold the wear strip 50 to the lateral support 48.

Each conveyor segment 22 has two upper side rails 42, as illustrated in the simplified cross-section of FIG. 11, with the lateral supports 48 extending toward each other and toward a longitudinal axis 54 extending down the centerline of the belt 36. The terms inner or inward, and outer or outward will refer to the location relative to the longitudinal axis 54.

Below each of the upper side rails 42 is a lower side rail 56, as best seen in FIGS. 11 and 6. For clarity, one of the upper lower side rails 56 is omitted in FIGS. 1-3. The lower side rails 56 are similar to the upper side rails 42. Each lower side rail 56 has a vertical support and a lateral support, is preferably made of the same material as upper side rails 42, and if made of metal preferably has an outwardly rolled upper edge 44 for added stiffness. The lower side rail 56 preferably has an L shaped cross section with the longer leg of the L comprising an elongated, flat strip, and the short leg of the L extending perpendicular thereto.

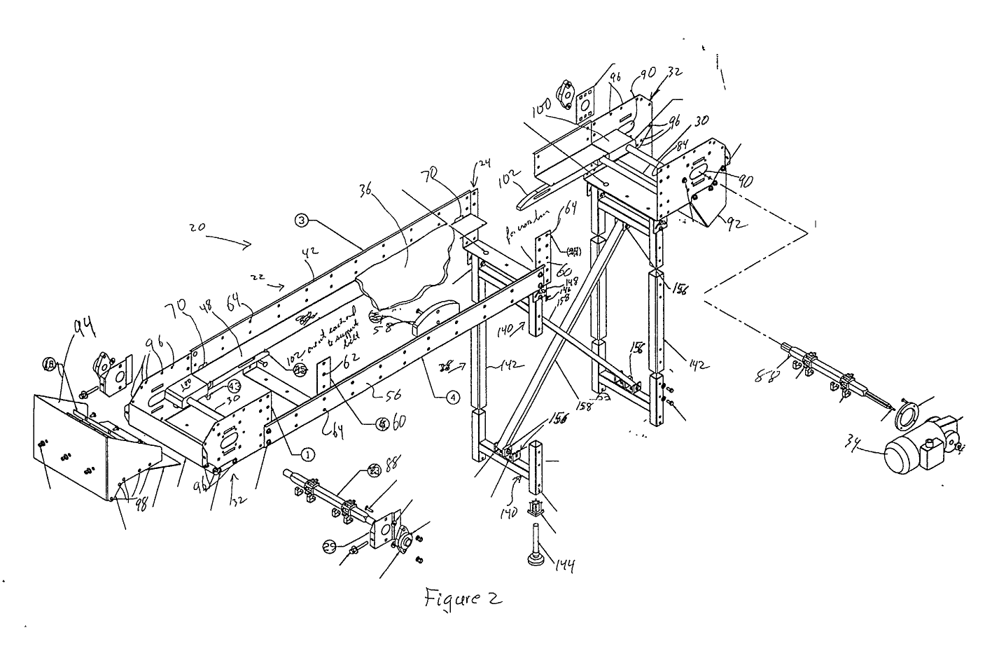

Referring to FIG. 2, a plurality of return belt supports 58 are connected to the inside of each of the lower side rails 56 in sufficient number and location to support the belt 36 for the intended use of the conveyor. Advantageously, the return belt supports 58 have a curved top as the return portion of the belt 36 rubs on the top and sags between adjacent supports 58. The curvature will vary with the tightness and construction of the belt 36, and those factors will vary with the intended use of the conveyor 20. The supports 58 preferably have a flat bottom that can rest against the short leg of the side rail 56. Threaded fasteners can extend through the return belt supports 58 and into the rails 56 in order to fasten the supports 58 to the inside of the lower side rails 56. The return belt supports 58 are located along the length of the lower side rails 56 at distances sufficient to adequately support the return portion of conveyor belt 36.

The upper and lower side rails 42, 56 are held in position by U-shaped supports 60 having opposing legs 60a, 60b, separated by a bottom 60c. The U-shaped supports 60 are preferably flat strips of material, preferably metal, that are bent into a U shape. Holes 62 are placed at predetermined locations in the legs 62a, 62b of the U-shaped supports 60 for fastening to the side rails 42, 56 and positioning the rails at predetermined locations, with further holes being located in the bottom 62c for possible connection to legs 28.

Referring to FIGS. 1-3 and 11, the side rails 42, 56 have pairs of aligned holes 64 at predetermined intervals along the length of the rails. If the rails 42, 56 are horizontal, there are two holes 64, vertically aligned and vertically spaced a predetermined distance apart, preferably about 2-4 inches, and located at intervals along the length of the rails. Preferably the intervals are constant, and about 6-8 inches. The holes 64 in opposing side rails 42a, 42b and 52a, 52b are also aligned laterally so a line perpendicular to longitudinal axis 54 extends through holes 64 in opposing side rails 42 or 52.

The U-shaped support 60 has holes 64 located to mate with the holes 62 in the side rails. As shown, there are a pair of holes 64 in the upper side rails 42, and the U-shaped support has a matching pair of similarly located holes 62. As shown, there are a pair of holes 64 in the lower side rails 56 and the U-shaped support 60 has a matching pair of holes 62. The U-shaped support 60 can thus be located at any of the aligned holes along the length of the conveyor segment 22. Depending on the intended use of the conveyor segment 22, the number of supports 60 can be increased to increase the strength and stiffness of the conveyor. The number of holes and strength of the U-shaped support 60 can also vary depending on the load to be carried.

Referring to FIG. 11, if the side rails 42, 56 have outwardly rolled edges 44, then the legs 60a, 60b of the U-shaped support 60 must accommodate those rolled edges 44. Appropriate slots could be cut in the side rails 42, 56 to allow passage of the support 60, or the rolled edges 44 could be removed at the location of the supports 60. But preferably the supports 60 are connected as shown in FIG. 11. The bottom 60c of the U-shaped support 60 rests against the short legs of the bottom rail 56, on the inside of the rails 56, with the opposing legs 60a, 60b resting against the inside of the longer legs of the side rails 56. Threaded fasteners can extend through the aligned holes 62, 64 to fasten the side rails 56 to the U-shaped support 60. The opposing legs 60a, 60b of the U-shaped support 60 extend on the outside of the upper side rails 42 and end before the rolled edge 44. Again, threaded fasteners can extend through the aligned holes 62, 64 to fasten the side rails 42 to the U-shaped support 60. This arrangement reduces the openings that must be formed in the rails 42, 56. It also results in the spacing between the upper side rails 42 being slightly smaller than the spacing between the lower side rails 56.

Advantageously, the holes 62 and/or 64 are threaded to eliminate the need for threaded nuts. Preferably, the holes 64 in the upper side rail 42 are punched out to form square holes to hold a carriage bolt and restrain rotation of the bolt. The carriage bolt can extend from the inside of the rail 42, through the upper, non-threaded mating holes 62 in the U-shaped support 60 so a nut could be threaded onto the end of the bolt from outside the rails 42. Conversely, the lower holes 62 in the U-shaped support 60 can be cut or punched out to form square holes to hold a carriage bolt from rotation. A carriage bolt inserted from inside the lower rails 56 would then extend through non-threaded holes in the lower rails 56 so a nut could be threaded onto the end of the carriage bolt from outside the rail 56. This advantageously provides an easy way to assemble the conveyor segment 22 and provide adjustable flexibility or stiffness to the conveyor segment.

Referring to FIGS. 2 and 11, the opposing legs 60a, 60b of U-shaped support 60 are shown as having five holes in each leg. The top two holes align with mating holes in the upper side rails 42. The bottom two holes align with mating holes in the lower side rails 56. The middle hole can be used to fasten an optional cross stiffener 66 that is added as needed to further strengthen and stiffen the conveyor segment 22.

Referring to FIGS. 1-3, an opening 70 is placed in the each of the side rails 42a, 42b, 56a, 56b. The openings 70 are aligned laterally and vertically so that a line perpendicular to the longitudinal axis 54 will extend through opposing openings 70. The openings 70 are large enough to that tools may be inserted to remove pins 72 that hold together adjacent segments 74 of the conveyor belt 36 together. Removing the pins 72 through the openings 70 allows removal of segments 74 of the belt. The openings 70 are shown as elongated slots formed in the vertical sidewalls of the side rails 42, 56, located adjacent the lower leg of each rail. The openings 70 are shown at opposing ends of the conveyor segment 22, allowing removal of a length of the belt 36 extending between the openings. The openings 70 could be located any desired distance apart to allow access to and removal of any desired length of conveyor belt 36.

Referring to FIGS. 1-2, if the conveyor segments 22 are joined in a straight line, the ends of upper and lower side rails 42, 56 are butted together and a plate extends across the joint to bolt them together. Preferably, a U-shaped bracket 80 is used to join adjacent segments 22 in a straight line. The bracket 80 has opposing legs 80a, 80b joined by a bottom 80c. The legs 80a each have aligned pairs of holes 82 in them. If the conveyor segments 22 are horizontal, the holes 82 preferably form a vertically aligned row of five pairs of holes, with each pair of holes being horizontally aligned. The end of the side rails 42, 56 are formed or cut to a desired length so the end occurs shortly after one set of the holes 64 in the side rails. A spacing of about 0.5 to 1 inch is typically suitable, with the distance varying with the load that must be supported by the joint and the dimensions of the parts used to form the joint. The holes 64 are located to align with the holes 82 in the bracket 80 so fasteners can be inserted through the aligned holes to connect the abutting ends of the adjacent conveyor segments 22.

Preferably the bracket 80 is placed on the inside of the lower side rails 56 and extend on the outside of the side rails 42. This is just like the connection of the U-shaped support 60 and will not be described again. Preferably, the bracket 80 has square holes 82 aligned with the holes 64 of the lower side rails 56, and round holes 82 aligned with the holes 64 in the upper side rails. This is also like the connection of the U-shaped support 60 to the side rails and will not be described again. Preferably, there is an additional pair of holes 82 located between the upper and lower side rails 42, 56 respectively, and these holes are optionally used to mount a support cross-stiffener or stiffeners 66 as previously described.

By varying the length of the side rails 42, 44, the length of the conveyor segment 22 can be adjusted. The side rails 42, 44 can be provided in predetermined lengths. On-site adjustments to the length can be made by cutting the length to suit,

The conveyor segments can also connect to end supports or end segments 32. The end supports 32 have aligned holes 84 located to form the connection described using bracket 80, and that description is not repeated. As shown in FIG. 2, the end support 32 has the construction of bracket 80 built into the mating end of the support 32 rather than having the bracket 80 be a separate piece. The pattern of the holes 82 used in the bracket 80 are thus formed in the joined end of the end segment, advantageously including the location of square and round holes described relative to the U-shaped bracket 80. Thus, the abutting ends of the upper rails 42 fit inside the end support 32, and the abutting ends of the lower side rails 56 fit outside the end support 32.

As previously described, there is only one line of holes 64 in the adjacent end of the rails 42, 56. But replicating the hole pattern of the bracket 80 in the abutting end of end support 32 leaves two parallel lines of matching holes 82. You can align the holes 64 in the side rails 42, 56 with either line of holes 82 in the end support 32, but that requires moving the conveyor segment by the amount of the spacing between holes. Effectively, the two lines of matching holes 82 are spaced apart and that spacing provides an ability to adjust the length of the conveyor segment 22 by the amount of that spacing. Further, each conveyor segment 22 has an end segment 32 at opposing ends of the segment 22, then each end can be adjusted to vary the length.

Preferably, the spacing between the lines of holes 82 is about 1.5 inches, providing about 1.5 inches of adjustable length for each end segment, or about 3 inches of total increase in length, or decrease in length. If the interval between holes 64 in the side rails 42, 56 are about 6 inches, the end supports allow an adjustment of about half that interval. The various hole spacings can be varied to provide the desired adjustability increments.

The end support 32 has suitable openings and connections to mount a drive motor 86 and conveyor drive shaft 88 in a conventional manner. Cross stiffeners 66 are added as appropriate. Advantageously, the dimensions of the end support 32 are selected to accommodate motors 86 that vary from 0.5 hp to 1.5 hp in 0.25 hp increments, with a suitable gearbox to maintain the desired speed of conveyor belt 36. Typically, a larger gearbox will be used with the smaller motor, and a smaller gearbox with a larger motor. But the precise combination will vary with the intended use of the conveyor 20. To accommodate the variable motor and gearbox combinations, slotted mounting holes 90 are provided for the motor 86 and drive shaft 88.

As appropriate, a chute 92 or hopper 94 can be connected to the end support 32. The connection is achieved by a pattern of aligned holes 96 along the periphery of the end support 32 which align with holes 98 in the chute 92 and hopper 94. Thus, the same end support 32 can be used to connect to either a chute 92 or hopper 94. Advantageously the holes 96 in the end support 32 are square so they can accept a carriage bolt inserted from the inside of the support 32. The bolt extends through aligned holes 98 in the chute 92 or hopper 94 so a nut can be threaded onto the bolt from outside the end support 32. That type of connection provides easy access to the connecting fasteners along with easy assembly and removal, while providing a sturdy connection.

In connecting the conveyor segments 22 to other segments 22 or to end supports 32, appropriate conveyor belt supports and guides are provided. Thus, nose wear blocks 100 located adjacent the drive shaft, and belt guides 102 for the return portion of belt 36 can be provided as needed. As illustrated in FIG. 2, the belt guide 102 can have an elongated slot through which a fastener can be inserted so the position of the fastener can be adjusted.

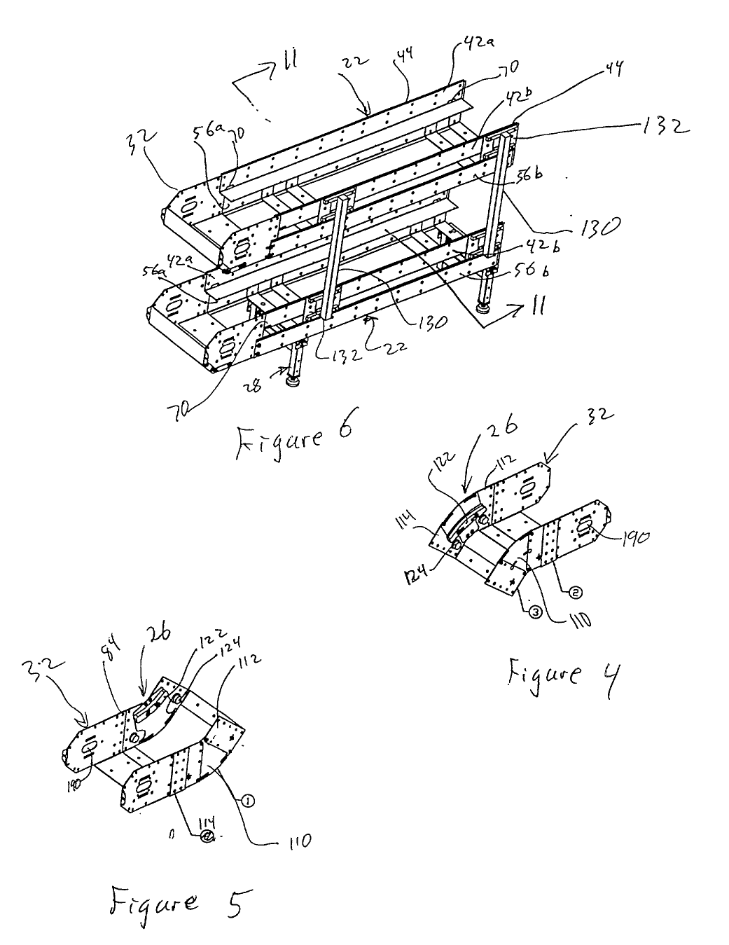

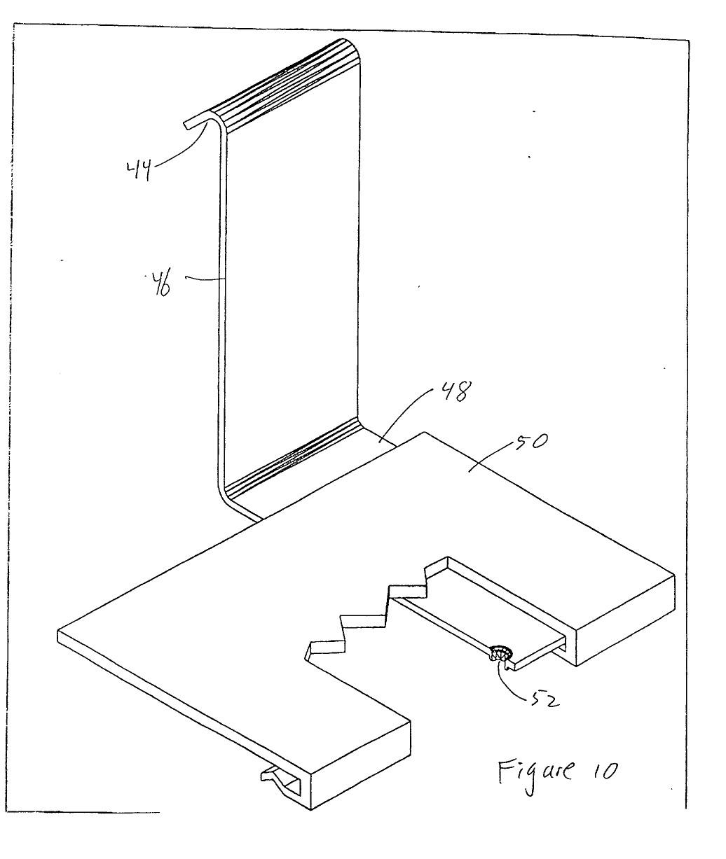

The conveyor segments 22 can also be joined at an angle by curved connector 26. Referring to FIGS. 1, 4-5 and 7-8, the curved connectors 26 have two opposing central support plates 110 with U-shaped end brackets 112, 114 having opposed legs, each of which is connected to on end of the adjacent central support plate 110. The curved connector 26 will be described with respect to the downwardly curved plate of FIGS. 4 and 7 and, but the upwardly curved support plate of FIGS. 5 and 9 is similar except it is turned upside down.

Referring to FIGS. 4 and 7, each central support plate 110 has two curved slots 116 at its upper end and a pair of pivot bolts 118 at its lower end. The pivot bolts 118 connect the bottom of the central plate 110 to the bottom of one leg of each end bracket 112, 114 so the brackets pivot about the bolts 118. A bolt 120 through each slot 116 and through an aligned hole in the corresponding end bracket 112, 114 allows the brackets to pivot about their respective bolts 118 to a desired angle, with the bolts 120 being fastened to hold the selected angle. Each curved slot preferably coincides with a radius of curvature having the corresponding pivot bolt 118 as the center of curvature. The dimensions will vary with the size needed to achieve the intended use of the conveyor 20. Curved slots 116 sufficient to allow adjustment of about 15-50 degrees are believed suitable. The central plate 110, brackets 112, 114 are made of a material selected to withstand the intended use of the conveyor, but are preferably metal.

The end brackets 112, 114 are mirror images in construction, each having one edge fastened to the central support plate 110, and an opposing edge that is fastened to either a conveyor segment 22 (FIG. 1) or an end support 32 (FIGS. 1, 4-5). The end of the support plate 112, 114 that fastens to the conveyor segment 22 of an end support 32 has the hole pattern previously described as mating with the U-shaped support 60 or the U-shaped bracket 80, and the description of that pattern is not repeated. The connection to the abutting conveyor segment 22 or end support 32 is the same as previously described for joining those previously described parts.

The end plates 112, 114 are U-shaped, preferably formed of strips of flat material bent to form a U with opposing legs forming a plate that overlaps with a portion of the central support plate 110. The upper curved support 26 has A central support plate 110 on the inside of each of the opposing legs of the U-shaped brackets 112, 114. It is believed possible that the central support plate 110 could also be a Ushaped bracket to provide increased stiffness and support, but if so the bottom must avoid contact with the bottoms of the U-shaped brackets 112, 114.

Connected to the inside of the curved connector 26, and fastened to the inside of each of the opposing support plates, are a curved conveyor support shoe 122, a roll 124 and belt return supports 126. The roll 124 supports the bottom of the return conveyor belt and is fastened to the central support plate just above the pivots 118 in FIG. 7. In an alternative embodiment shown in FIGS. 1 and 4, there is a roll 124 connected to each opposing leg of the U-shaped end bracket 112, 114.

The conveyor support shoe 122 supports the bottom of the drive conveyor belt 36 in use, and is an elongated part with a curved top to match the curve of the path of the conveyor belt 36. The belt support shoe is made of suitable material, like that used in support 58, nose block 100 or belt guide 102. Each belt support shoe 122 has one end mounted to one of the opposing legs of U-shaped brackets 112, 114, and an opposing end mounted to the other leg of the other bracket 112, 114. Bolts extending from inside the curved connector 26 connect the parts, with the bolts extending through slots 128 in the support shoe 122 and central plate 110. The slots 128 are in the plane of the central plate 110 and shoe 122, and straight, to accommodate the variable angle at which the curved connector 26 can be set.

There are preferably two belt return supports 126 on opposing sides of each central plate 110. One return support 126 is connected to each of the opposing legs of the U-shaped end bracket 112, 114, and located to support the bottom of the return portion of belt 36. The return supports 126 preferably extend beyond the edges of the opposing legs of the U-shaped brackets 112, 114 so they guide the belt 36 into the adjacent part of the conveyor.

Referring to FIG. 1, the downwardly curved connector 26 is shown having its upper end fastened to a segment of a horizontal conveyor, with one end bracket 112 connecting to the horizontal conveyor segment 22 and the other end bracket 114 connecting to the inclined conveyor segment. When connecting to a conveyor segment 22, the upper portion of the opposing legs of brackets 112, 114 goes on the outside of the upper rails 42, and the lower portion of the opposing legs of brackets 112, 114 goes on the inside of the lower guide rails 56, just like the U-shaped support 60.

Referring to FIG. 4, the downwardly curved connector 26 is shown having its upper end connected to an end support 32. In this connection, the free edge of brackets 112 abuts the free end of support 32, and a plate having holes to match the holes in the end support 32 and bracket 112 is placed over the butt joint, and fasteners inserted through the holes. If added support is desired, a U-shaped bracket can be used with the opposing legs overlapping the butt joint and the bottom of the U abutting the bottom of the joined parts.

The upwardly curved connector 26 is like the downwardly curved connector, except it is inverted. The description will not be repeated. The downwardly curved connector 26 shown in FIGS. 1 and 5 does show an alternative arrangement of the rolls 124. In an alternative embodiment there is a roll 124 connected to each opposing leg of the U-shaped end bracket 112, 114, with the central support plate 110 having edges shaped to avoid hitting the rolls 124 when the angle of the curved connector 26 is expanded to a large angle.

Referring to FIG. 6, the conveyor 20 can be stacked. Mounting brackets 132 are placed at vertically corresponding locations on two conveyor segments 32 that are to be stacked vertically. An offset is then connected to the vertically aligned mounting brackets 132 to vertically stack the conveyor segments and space them a predetermined distance apart.

The conveyor segments 32 are also adjustable in vertical height by adjustable legs 28. Referring to FIGS. 1 and 9, an H-shaped bracket 140 is formed of suitable material, preferably metal tubing with a square cross-section, although the material and shape will vary with the intended use of the conveyor 20. The two opposing legs of the H-shaped bracket 140 are orientated vertically. An intermediate support 142 has a correspondingly shaped cross-section, but slightly larger to fit over the vertical legs in order increase the height of the legs 28. The lower ends of the intermediate sections 142 hit the cross-bar of the H-shaped bracket and are held in position by threaded fasteners extending through aligned holes formed in the legs of the bracket 140 and the lower end of intermediate supports 142. Through bolts can be used, or some of the holes can be internal threaded. By changing the length of the intermediate supports 142, the gross height of the legs 28 can be changed.

The lower ends of the vertical legs of the H-shaped bracket 140 can have feet 144 inserted into them in order to distribute the weight of the conveyor on the floor on which the feet rest. The cross-bar on the H-shaped bracket 140 is preferably offset so it is closer to one end of the vertical legs, making shorter and longer vertical legs on the bracket 140. The feet 144 are preferably inserted into the short legs of the bracket.

The H-shaped bracket 140 is also placed on the upper ends of the intermediate supports 142 and again fastened by threaded fasteners extending through aligned holes in the bracket 140 and intermediate supports 142, as described in more detail above. When placed on the upper ends of supports 142, the H-shaped bracket 140 is inserted so the longer legs of the bracket 140 engage the supports 142.

An angularly adjustable, connector bracket 146 is placed onto the H-shaped bracket 140 for connecting to the conveyor 20. The connector bracket 146 is U-shaped, preferably having short, opposing legs 146a, 146b connected by a longer bottom 146c. It can be bent out of a strip of flat metal. At least one and preferably both of the opposing legs 146a, 146b of the connector bracket 146 have a curved slot 148 having a radius of curvature about a pivot hole through which a bolt 150 extends. An additional locking hole and locking bolt 152 are provided toward the distal end of each leg 146a, 146b of the H-shaped bracket 140. The locking hole and bolt 152 are vertically aligned with the pivot hole and bolt 150, so that when bolts 150, 152 are tightened, the bottom 146c of the U-shaped connector bracket 146 is held in a rigid position. It is intended the bottom 146c be flat and horizontal in this orientation in order to help lock the legs 28 into a vertical orientation and allow the conveyor 20 to be connected to the bottom 146c to form a sturdy support for a horizontal conveyor.

By removing the locking bolt 152, and inserting a bolt through the slot 148 into a hole aligned with the slot, the bottom 146c can be angled relative to the vertical plane of the legs 28. That allows the vertical legs 28 to have an angled connection to an inclined conveyor segment. The bottom 146c of the connector bracket 146 preferably has a hole pattern that coincides with a hole pattern in the bottom of U-shaped support 60c and U-shaped bracket 80c. Fasteners can be inserted through these aligned holes to form a sturdy connection, with the number of holes and size of fasteners being varied depending on the intended use of the conveyor 20.

The H-shaped bracket 140 preferably has at least one U-shaped connector 156 on the cross-bar of the bracket 140. A cross-support bar 158 has one end connected to the connector 156, and an opposing end connected to another connector 156 on an adjacent H-shaped bracket 140. Preferably, the each end of the bar 158 extends between the opposing legs of the U-shaped connector 156 and is pinned between those opposing legs. This allows the cross-support bar 158 to pivot about the pinned connection, but not change length. The cross-support bars 158 can extend diagonally from a lower H-C shaped bracket 140 to an upper H-shaped bracket on an adjacent leg 28. By placing two U-shaped connectors 156 on adjacent legs 28, an X support can be achieved. The cross-support bars 158 can also extend horizontally between H-shaped brackets 140 located at the lower ends of adjacent legs 28 or between brackets located at the upper ends of adjacent legs 28. The bars 158 can extend beyond adjacent legs and interconnect legs 28 that are not adjacent in each of the above configurations. Other combinations of these connections can be used.

What is claimed is:

1. A curved connector for a modular conveyor, comprising:
a central plate having a top and bottom on opposing ends of two opposing sides, the plate having at least one curved slot adjacent one of the top and bottom and having at least one pivot hole adjacent the other of the top and bottom; and
a first end bracket connected to one side of the central plate by a first fastener extending through the curved slot and by a second fastener extending through the at least one pivot hole.

2. A curved connector as defined in claim 1, further comprising:
a second end bracket connected to the other side of the central plate by a third fastener extending through the curved slot and by a fastener extending through the at least one pivot hole.

3. A curved connector as defined in claim 2, wherein there are a first and second pivot hole with a fourth fastener extending through the second pivot hole.

4. A modular conveyor comprising:
at least two straight conveyor segments having a belt that travels along a longitudinal axis of the segments, the segments having a pair of upper side rails disposed on opposing sides of the longitudinal axis and located above a pair of lower side rails disposed on opposing sides of the longitudinal axis, the upper side rails supporting wear pads extending toward the opposing upper side rail to support the conveyor belt, the side rails being connected to a U-shaped support that extends along an inside of one of the upper and lower sidewalls, and that extends along an outside of the other of the upper and lower sidewalls, with fasteners connecting the sidewalls to the support.

5. The modular conveyor as defined in claim 4, wherein the top edges of at least some of the rails are rolled to increase strength of the rails, and wherein the Ushaped support connects to the inside of the lower side rails and connects to the outside of the upper side rails.

6. The modular conveyor as defined in claim 4, wherein the conveyor belt comprises adjacent segments joined by pinned connections, and wherein a aligned access holes are placed in the sides of the upper or lower side rails, the access holes being located relative to the belt to allow access to the belt sufficient to remove a pin holding two adjacent belt segments together.

7. The modular conveyor as defined in claim 4, wherein the side rails contain a plurality of paired mounting holes at predetermined intervals along a length of the side rails, the paired mounting holes being spaced apart a distance that matches the spacing of mating paired mounting holes formed in the U-shaped support so the holes in the support align with the holes in the side rails to allow threaded fasteners to be inserted therethrough to fasten the rails to the support.

8. The modular conveyor as defined in claim 4, wherein an end support is connected to one end of one of the conveyor segments, the end support supporting a motor and drive shaft placed in driving connection with the belt, the end support having an end abutting an adjacent end of the conveyor segment, the abutting ends having correspondingly located holes and the ends configures so the ends can overlap and allow fasteners to be inserted through the holes to fasten the end support to the end of the adjacent conveyor segment.

9. The modular conveyor as defined in claim 4, wherein the upper side rails abut an inside portion of the end support, and the lower side rails abut an outside portion of the end support.

10. The modular conveyor as defined in claim 4, further comprising legs holding the conveyor above a surface, the legs comprising two H-shaped segments having vertical legs spaced apart and connected to a removable intermediate support member having a length selected to vary the height of the conveyor, an upper H-shaped segment having a U-shaped bracket with opposing legs connected by an intervening connecting plate, each opposing leg of the U-shaped bracket having a pivot hole and a curved slot therein with a fastener extending through each pivot hole and fastened to one of the opposing legs of the H-shaped bracket to connect the U-shaped bracket to the H-shaped bracket so the U-shaped bracket pivots about a common axis, with a fastener extending through the curved slot and into one leg of the H-shaped segment in order to fasten the U-shaped bracket at a selected angle, with the intermediate support member being fastened to the conveyor.

11. The modular conveyor as defined in claim 10, fuirther comprising a hole located in the U-shaped bracket and coinciding with a hole located on a leg of the upper H-shaped segment to hold the U-shaped bracket so the legs of the U-shaped bracket are aligned with the legs of the upper H-shaped bracket.

12. The modular conveyor as defined in claim 11, wherein there are a plurality of legs having a plurality of upper and lower H-shaped segments, and a plurality of cross-support members each having opposing ends - fastened to a crossmember of the H-shaped segment.

13. The modular conveyor as defined in claim 11, wherein the ends of the cross-support members are pinned to the cross-members of the H-shaped segments.

14. The modular conveyor as defined in claim 11, further comprising a curved connector as defined in claim 1 connected to an end of one of the conveyor segments.

15. A kit for a modular conveyor comprising:
a plurality of side rails, the side rails having pairs of holes at intervals along a length of the rails, a plurality of the pairs of holes being aligned along a width of the side rails;
a plurality of U-shaped supports having opposing legs joined by a bottom segment with holes formed in the legs at locations coinciding with the spacing of the paired holes in the side rails; and
an end support having an end configured to mount to the side rails, the end containing holes spaced to coincide with the holes of the paired holes in the side rails, the end support having holes adapted to receive and mount a motor and gearbox and drive shaft so as to rotate a conveyor belt.

16. The kit of claim 15 wherein the side rails have a rolled edge for strength, and wherein the upper side rails have an L-shaped cross section with one leg adapted to support a wear pad and the other leg containing the paired holes located at intervals along the length of the rail.

17. The kit of claim 15, wherein at least two of the side rails have access holes in them at corresponding locations, the access holes being located so that the side rails can be placed parallel to each other on opposing sides of a conveyor belt when assembled, with the holes allowing allow access to the belt sufficient to remove a pin holding two adjacent belt segments together.

18. The kit of claim 15, further e comprising a curved connector as defined in claim 1.
